(19) United States
(12) Patent Application Publication
(10) Pub. No.: US 2011/0024239 A1
(43) Pub. Date: Feb. 3, 2011

(54) OPERATING METHOD FOR AN ELEVATOR WITH TWO ELEVATOR CARS AND A COUNTERWEIGHT

(76) Inventors: Hans Kocher, Udligenswil (CH); Jan Andre' Wurzbacher, Zurich (CH); Jean-Philippe Escher, Thalwil (CH)

Correspondence Address: FRASER CLEMENS MARTIN & MILLER LLC, 28366 KENSINGTON LANE, PERRYSBURG, OH, 43551, US

(21) Appl. No.: 12/809,754

(22) PCT Filed: Dec. 8, 2008
(86) PCT No.: PCT/EP2008/066990

§ 371 Date: Sep. 20, 2010

(30) Foreign Application Priority Data
Dec. 21, 2007 (EP) 07124017.0

(51) Int. Cl. B66B 5/00; B66B 1/18; B66B 9/00

(52) U.S. Cl. 187/249

(57) ABSTRACT

Evacuation method for a lift with at least three lift bodies which are moved along at least one travel path and are connected together by way of support and traction means, wherein the first and the second lift bodies are suspended 1:1 by means of the support and traction means and the third lift body is suspended 2:1 by means of the support and traction means. The three lift bodies can each be blocked by way of a respective controllable blocking device. If passengers are present in a first one of the three lift bodies a further second or third lift body is blocked. In the case of presence of an imbalance between the weight masses of the two remaining unblocked lift bodies the first lift body is moved to an evacuation storey.

The invention relates to an operating method for a lift with two lift cages and a counterweight mass according to the introductory part of the independent patent claim.

Such lifts are known from, for example, EP 1 329 412 A1. The lift system described there comprises two lift cages in a common lift shaft, with a respective drive and with a common counterweight.

Notwithstanding all safety precautions, it repeatedly happens that passengers are trapped in a lift cage. This is critical particularly when a lift cage in the case of motor or power failure remains stuck in the shaft at any intermediate storey. An incident of this kind is extremely unpleasant for the passengers of a lift cage involved, because until the passengers can be freed from the lift cage it is usually necessary to summon service personnel and to a degree initiate quite complicated and time-intensive evacuation measures. Quite long waiting times for a lift user can thereby arise.

The object of the present invention is to further improve a lift system of the kind described in the introduction.

The above-mentioned object is fulfilled by the invention in accordance with the definition of the independent claim.

The inventive operating method is conceived for a lift with at least three lift bodies which are movable along at least one travel path and are connected together by way of support and/or traction means. The first and the second lift bodies have 1:1 suspension by means of the support and/or traction means and the third lift body has 2:1 suspension by means of the support and/or traction means. At least one of the three lift bodies can be blocked by way of a controllable blocking device. If passengers are transported in a first one of the three lift bodies a second lift body is blocked. In the case of presence of an imbalance between the weight masses of two unblocked lift bodies the first lift body is moved to an evacuation position.

The evacuation position is preferably an evacuation storey at which trapped passengers leave the lift body. A further possible evacuation position is at the upper or lower shaft end, wherein the passengers disembark from the lift by way of, for example, a maintenance, ventilating, window or roof opening. However, the evacuation position can be any desired position in the shaft in which the passengers leave the lift body or lift.

The advantage of the operating method resides in the fact that after failure of the motor a lift cage together with passengers can be further moved without delay to an evacuation storey with the assistance of gravitational force. Trapped passengers thus go rapidly and, for them, comfortably to an evacuation storey at which they can leave the lift cage. Thus, no service personnel are necessary in order to evacuate the passengers from the lift cage and unpleasant waiting times are largely avoided.

Advantageously, in the operating method passengers are transported in the first and second lift bodies. The third lift body is blocked and one of the other lift bodies is moved into an evacuation position, in accordance with a determinable criterion, in the case of presence of an imbalance between the weight masses of the two unblocked lift bodies. The criterion comprises, for example, at least one of the following criteria: smaller distance to the evacuation position, higher number of passengers, or presence of a passenger by way of which an identity profile is detected.

The lift has a lift control, which is preferably in communication with different system elements of the lift, for determining and detecting the criterion. These system elements are, for example, a shaft information system, which inter alia generates information about the cage positions in the lift shaft, a weight force measuring apparatus, which measures the current load weight of a lift cage, an image detection apparatus, which monitors the interior space or the access space of a lift cage, or an access control unit, which, for example, assigns an identity to a boarding passenger.

The advantage of the operating method is that as a consequence of a situation an optimal evacuation of the passengers of a lift body takes place. If the situation requires, for example, the passengers to evacuate a lift body particularly quickly, then the passengers are evacuated from that lift body which has the smallest travel distance to an evacuation position. Accordingly, the lift control compares, on the basis of data of the shaft information system, in particular the position of the lift cages in the shaft, the travel distance of the lift cages to an evacuation position and prioritises the evacuation of that lift cage with the smallest travel distance to the evacuation position.

Preferably, that lift in which more passengers are present can in targeted manner also be moved first to an evacuation position, because the available space of the lift body per lift passenger is smaller in this lift body. Thus, waiting times in such a lift body are particularly unpleasant for the passengers and the occurrence of panic reactions higher than average. In addition, a greater number of passengers can be evacuated more quickly. The prioritising of the evacuation of a lift cage on the basis of the number of passengers is taken by the lift control preferably on the basis of a measurement of the load weight by the weight force measuring apparatus, detection of the number of passengers by the image detection apparatus or the identification of the passengers by the access control unit.

In the case of use of the lift by passengers with a known identity profile, such as high level political officials, business managers or other persons of public interest, the situation can require these to be evacuated first at an evacuation position. For this purpose in one possible embodiment the lift control compares the identity profiles of the passengers detected by the access control unit and prioritises the evacuation of that lift cage in which a passenger with a corresponding identity profile is present.

In addition, an evacuation position is determined by a control unit, preferably the lift control. A position along the travel path of a lift cage is suitable as evacuation position on the basis of, for example, the following criteria: spatial proximity to the lift cage to be evacuated, distance to building exits, availability of escape routes for leaving a building, safety aspects such as a fire or persons on violent rampage and other situation-specific criteria.

For the purpose of establishing the evacuation storey the control unit has data available which are ascertained by different systems of the lift communicating with the control unit: a shaft information system which communicates the positions of the lift cages to the control unit, monitoring cameras, infrared sensors, fire alarms or other installations at the building which communicate data with respect to the availability of escape routes from the building or with respect to the safety of passengers on a storey or a memory unit which is allocated to the control unit and has stored the position of storeys and building exits.

Advantageously an upper lift body has a lowerable weight. In the operating method the lowerable weight is lowered onto a lower lift body so as to produce a weight force difference between a first and a second unblocked lift body. Additionally or alternatively a lower body can also have a lowerable weight which is lowered onto the shaft floor. In that case a weight force difference is similarly produced between a first and a second unblocked lift body. For the purpose of lowering the weight a lift body, preferably a lift cage, is equipped with a winch. This winch is arranged in the lower region of one of the lift bodies. A support means at which the weight is suspended is wound up on the winch. The winch is equipped with a motor, preferably an electric motor, in order to wind up or unwind the support means, wherein the weight hanging thereat is correspondingly raised or lowered. The motor of the winch selectably has a manual operation actuable from the interior space of a lift cage. In order that the weight during use thereof in the evacuation method rests on the lift cage thereunder or the shaft floor the winch is controlled or regulated by a control unit, preferably the lift control. For that purpose the winch has sensor means which supply to the control unit, for example, data about the support means tension or the torque of the motor. In a preferred embodiment the control unit accesses data of a shaft information system with details about position and speed of the lift cages and calculates therefrom a support means length to be unwound.

The advantage of the lowerable weights in the operating method is that independently of the weight distribution of the different lift bodies an imbalance, which is required for the movement of the lift body to an evacuation position, can always be produced.

Advantageously the lift has an emergency power unit in order to ensure power for performance of the operating method. The emergency power unit is preferably a battery or an emergency power component. It supplies the lift control and the lift systems participating in the operating method, such as, for example, holding brakes, cage brakes, blocking units, information and display means, cage and shaft doors as well as optionally the electric motor of the winch of the lowerable weight, with power.

The advantage of the emergency control unit which is present resides in the fact that the operating method can be performed even in the case of a power failure.

The inventive evacuation method is controlled or regulated by a control unit, preferably the lift control, and preferably also monitored. For this purpose the lift control is connected by way of a communications network with, for example, the blocking units of the lift bodies, the drives, particularly the holding brakes thereof, regulated cage brakes, a shaft information system, a weight force measuring apparatus, an access control unit, an image detection unit, information and display means, means for detecting the building state, for example fire sensors, safety cameras or infrared sensors, the door drives of the cage and shaft doors, the winch, particularly the motor thereof, as well as a safety device of the lift and further means involved in the operating method.

The invention is clarified and further described in detail in the following by examples of embodiment and drawings, in which:

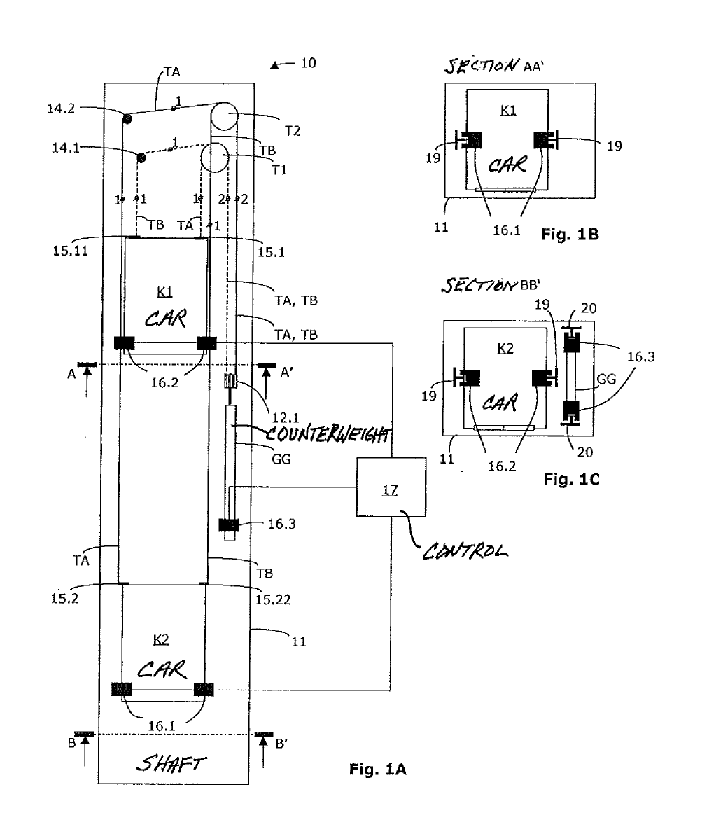

FIG. 1A shows an arrangement of a lift with two lift cages and a counterweight;

FIG. 1B shows the lift illustrated in FIG. 1A in a section along the line A-A′ in FIG. 1A;

FIG. 1C shows the lift illustrated in FIG. 1A in a section along the line B-B′ in FIG. 1A:

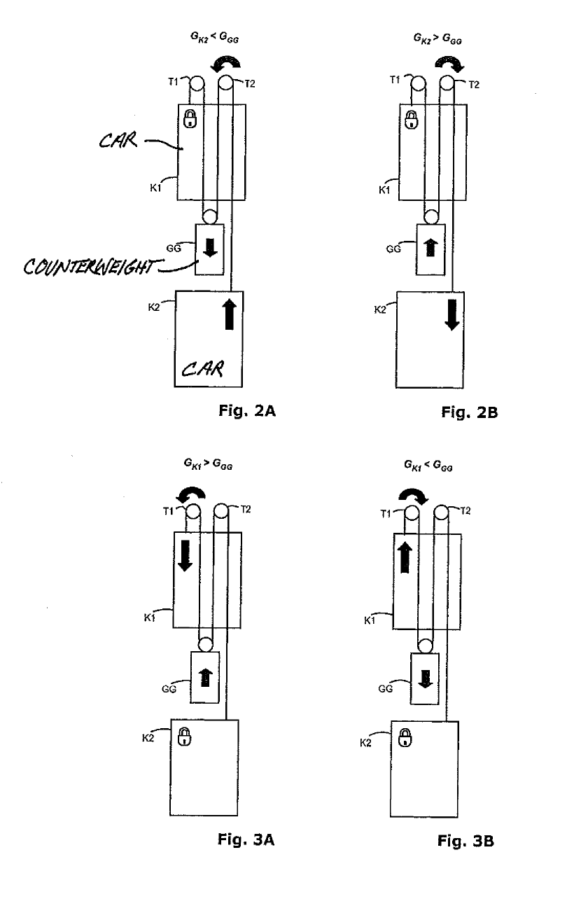

FIG. 2A shows a diagram of a first example of embodiment of the evacuation method according to the invention with a first weight distribution between a counterweight and a lower lift cage;

FIG. 2B shows a diagram of a second example of embodiment of the evacuation method according to the invention with a second weight distribution between a counterweight and a lower lift cage;

FIG. 3A shows a diagram of a third example of embodiment of the evacuation method according to the invention with a first weight distribution between a counterweight and a lower lift cage;

FIG. 3B shows a diagram of a fourth example of embodiment of the evacuation method according to the invention with a second weight distribution between a counterweight and a lower lift cage;

FIG. 4A shows a diagram of a fifth example of embodiment of the evacuation method according to the invention with a second weight distribution between two lift cages;

FIG. 4B shows a diagram of a sixth example of embodiment of the evacuation method according to the invention with a second weight distribution between two lift cages;

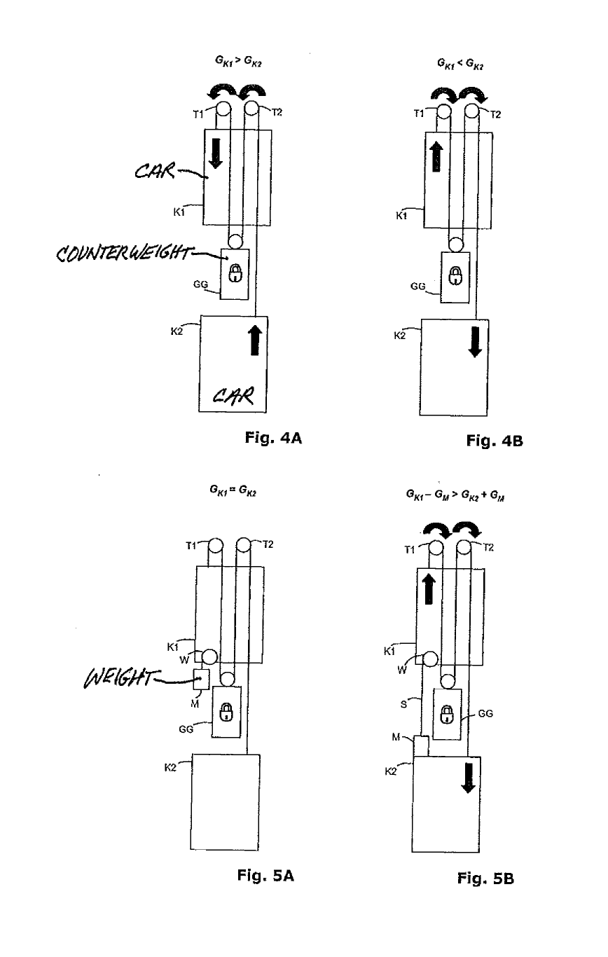

FIG. 5A shows a diagram of a lift with two lift cages and with a lowerable weight at the upper lift cage;

FIG. 5B shows a diagram of a seventh example of embodiment of the evacuation method according to the invention with a lift arrangement according to FIG. 5A;

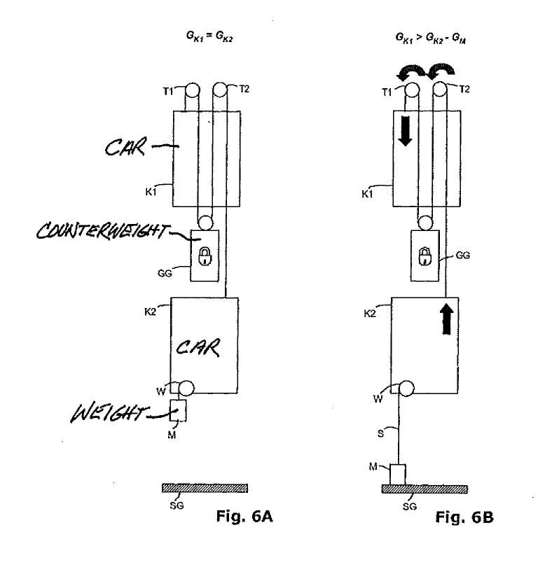

FIG. 6A shows a diagram of a lift with two lift cages with a lowerable counterweight at the lower lift cage; and

FIG. 6B shows a diagram of an eighth example of embodiment of the evacuation method according to the invention of FIG. 6A with a fourth, forced weight distribution between two lift cages.

The following generally applies to the drawing and the further description:
The figures are not to be regarded as true to scale.
Identical or similar constructional elements, or constructional elements with identical or similar effect, are provided in all figures with the same reference numerals.
Statements such as right, left, upper, lower refer to the respective arrangement in the figures.
Deflecting rollers and deflecting auxiliary rollers as well as drive pulleys are in general illustrated in sections perpendicular to the axes of rotation thereof.

FIGS. 1A, 1B and 1C show an exemplary embodiment according to the invention of a lift 10. These are schematic side views or sections, on the basis of which the fundamental elements of the lift 10 are explained.

An upper lift cage K1 and a lower lift cage K2 of the lift 10 are disposed one above the another in a common lift shaft 11 in which they can move independently of one another. Instead of the lift shaft 11 any structure such as, for example, a steel tube construction, at which the lift 10 can be mounted, can be provided.

In addition, a common counterweight GG is disposed in the lift shaft 11. The counterweight GG is suspended at an upper counterweight deflecting roller arrangement 21.1 in a so-called 2:1 suspension. A roller arrangement with more than one roller is also to be understood by the expression counterweight deflecting roller.

A first drive pulley T1 for the upper lift cage K1 and a second drive pulley T2 for the lower lift cage K2 are disposed in the upper region of the lift shaft 11. Each of these drive pulleys T1, T2 is coupled with an own drive, which is coupled with the associated drive pulley T1, T2.

Moreover, a first deflecting roller 14.1 is associated with the upper lift cage K1 and a second deflecting roller 14.2 is associated with the lower lift cage K2, the two deflecting rollers being disposed in the upper region of the lift shaft 11.

The upper lift cage K1 has, in its upper region, a first fastening point 15.1 on the left and a second fastening point 15.11 on the right. The lower lift cage K2 has, similarly in its upper region, a third fastening point 15.2 on the right and a fourth fastening point 15.22 on the left. The lift cages K1 and K2 are suspended in a so-called 1:1 suspension at flexible support means TA, TB, as is described in detail further below.

The support means substantially consists of a first support means run TA and a second support means run TB, each of which has a first end and a second end. The support means runs TA, TB are fixed to the lift cages K1 and K2 at the fastening points 15.1, 15.11, 15.2, 15.22 in such a manner that each of the lift cages K1 and K2 is suspended at each of the support means TA and TB. Advantageously, each of the support means runs TA and TB is formed by two or more parallel support means elements such as, for example, two belts or two cables. Each support means run TA and TB can, however, also comprise only belt or one cable. The supporting structure of the support means runs TA and TB is advantageously made of steel, aramide or Vectran.

The first support means run TA is fastened by its first end to the upper lift cage K1 at the second fastening point 15.1 and runs from there upwardly to the first drive pulley T1, around which it is guided with a looping angle of at least 180°.

The second support means run TB is fastened by its first end to the upper lift cage K1 at the first fastening point 15.11, runs from there upwardly to the first deflecting roller 14.1 and further to the right to the first drive pulley T1, around which it is led with a looping angle of 90°.

The two support means runs TA and TB run from the drive pulley T1 together parallelly in downward direction to the upper counterweight deflecting roller 12.1, where they are deflected through 180°.

From the upper counterweight deflecting roller 12.1 the two support means runs TA and TB run together upwardly towards the top to the second drive pulley T2. The first support means run TA is led around the second drive pulley T2 with a looping angle of at least 90°. The second support means run TB is led around the second drive pulley T2 with a looping angle of at least 180°. From the second drive pulley T2 the first support means run TA runs to the left to the deflecting roller 14.2 and then to the third fastening point 15.2 at the upper lift cage K2, at which its second end is fastened. Similarly, from the second drive pulley T2 the second support means run TB runs downwardly to the fourth fastening point 15.22 at the lower lift cage K2, at which its second end is fastened.

A guide device for vertical guidance of the cages K1 and K2 in the lift shaft 11 comprises two stationary guide rails 19 which extend vertically along opposite sides of the lift shaft 11 and are fastened in a manner which is not illustrated. The guide device additionally comprises guide bodies (not illustrated). Mounted at both sides on each of the cages K1 and K2 are preferably two guide bodies in vertically aligned arrangement, which co-operate with the respective guide rails 19. The guide bodies at each side of the cages K1 and K2 are advantageously mounted at a largest possible vertical spacing.

The counterweight GG is arranged in the region of one of the guide rails 19 and moves, with vertical guidance, similarly longitudinally of this guide rail 19 at counterweight guide rails 20, wherein the guide rail 19 is arranged between the lift cages K1 and K2 on the one hand and the counterweight GG on the other hand.

The two lift cages K1, K2 as well as the counterweight GG each have a blocking device 16.1, 16.2 or 16.3. These blocking devices 16.1, 16.2, 16.3 are in communication with a control unit 17. This control unit 17 can be arranged centrally as shown in FIG. 1a. However, a decentral solution with several control units communicating with one another is also possible, which, for example, are positioned on a lift cage K1, K2 or a counterweight GG.

The function of the blocking device 16.1, 16.2, 16.3 is to block the associated lift cages K1, K2 or the associated counterweight GG in relation to the guide rails 19, 20 thereof. For that purpose the blocking device 16.1, 16.2, 16.3 can come into operative contact with the associated guide rails 19, 20. A blocking unit 16.1, 16.2, 16.3, preferably knows two states, namely an open state in normal operation, which permits a free movement of a lift cage K1, K2 or a counterweight GG relative to the guide rails 19, 20, or a closed state, in which the blocking device 16.1, 16.2, 16.3 prevents the lift cages K1, K2 and/or the counterweight GG from a movement relative to the guide rails 19, 20, thus blocks. The control unit 17 determines the state of a blocking device 16.1, 16.2, 16.3 and transmits corresponding control commands to the blocking device 16.1, 16.2, 16.3.

In addition, this control unit 17 is in communication with a lift control (not shown) or in a preferred alternative form of embodiment is the lift control itself or part of this lift control. The lift control controls the lift, particularly the drives which are associated with the drive pulleys T1, T2 and which usually have a motor and a holding brake. In an alternative form of embodiment, regulated cage brakes, which are similarly controlled or regulated by the lift control, are mounted on the cages, in addition to or instead of the holding brakes. These regulated cage brakes act on the guide rails 19. In a particularly advantageous embodiment a regulated cage brake can also function as blocking device 16.1, 16.2.

The lift control obtains, inter alia, data about storey position, building state, particularly the availability of storeys, for example, in the case of fire as well as position and weight mass of the lift cages K1, K2.

The principle of function of a variant, which is designed as an evacuation method, of the operating method according to the invention is shown in schematic diagrams in FIGS. 2A to 6B. Two drive pulleys T1, T2 are illustrated in the shaft region above the upper lift cage K1. A first drive pulley T1 is associated with the upper lift cage K1 and a second drive pulley T2 is associated with the lower lift cage K2. Each of these drive pulleys T1, T2 is driven by a separate drive, which has a motor and a holding brake. The lift cages K1, K2 are connected with a counterweight by way of traction and holding means. An upper lift cage K1 optionally has, as shown in FIGS. 5A to 6B, a lowerable weight M. This lowerable weight M is suspended at a support means S at a winch W. In a further advantageous alternative according to FIGS. 6A and 6B the lower lift cage K2 has a lowerable weight which is suspended by way of support means at a winch. In a particularly advantageous embodiment the two lift cages K1, K2 are equipped with a lowerable weight M.

In a first example of embodiment according to the invention in accordance with FIGS. 2A and 2B at least passengers in the lower lift cage K2 are trapped in the event of failure of the drives. The upper lift cage K1 at this point in time is empty, the passengers of which have a lower evacuation priority by comparison with the passengers of the lower lift cage K2, or the weight force relationships between the lift cages K1, K2 and the counterweight GG cause a blocking of the upper lift cage K1.

In order now to evacuate the passengers of the lower lift cage K2, the upper lift cage K1, for example, is blocked by means of a blocking device. In a second step the holding brake of the associated drive and/or a regulated cage brake of the lift cage K2 is released, whereby the drive pulley 12 of the lift cage K2 and/or the lift cage K2 itself is or are freed. According to FIG. 2A the weight mass GK2 of the lower lift cage K2 is lighter than the weight mass GGG of the counterweight GG. An imbalance between the weight mass GK2 of the lower lift cage K2 and the weight mass GGG of the counterweight is thus present. If this imbalance is sufficient for movement of the lift cage K2, the lift cage K2 is moved.

Consequently, the lower lift cage K2 moves upwardly to an evacuation position and the associated drive pulley T2 rotates in counterclockwise sense. A holding brake generates, during the evacuation travel, a braking moment opposing the rotational movement of the drive pulley T2 and/or a cage brake produces a braking force opposite to the movement direction of the lift of the lift cage K2 so as to control the travel speed of the lift cage K2 and so as to stop the lift cage K2 at the evacuation position determined by the lift control.

FIG. 2B shows a second example of embodiment according to the invention with opposite starting position. Here the weight mass GK2 of the lift cage K2 is heavier than the weight mass GGG of the counterweight GG, with the consequence that the lower lift cage K2 moves downwardly to an evacuation position.

FIGS. 3A and 3B show a third and fourth example of embodiment according to the invention, in which passengers are present at least in an upper lift cage K1 and are evacuated after failure of the motors.

In a first step here the lower lift cage K2 is blocked by means of a blocking device. Subsequently, in a second step a holding brake of the associated drive and/or a regulated cage brake of the upper lift cage K1 is released. The associated drive pulley T1 moves, as illustrated in FIG. 3A, in counterclockwise sense, since the weight mass GK1 of the lift cage K1 is heavier than the weight mass GGG of the counterweight GG.

There is thus an imbalance between the weight mass GK1 of the upper lift cage K1 and the weight mass GGG of the counterweight GG, which is used for movement of the upper lift cage K1 into a lower evacuation position. The holding brake and/or the regulated cage brake generate a braking moment opposite to the rotational sense of the drive pulley T1 or a braking moment opposite to the movement direction of the upper lift cage K1 so as to keep the travel speed of the lift cage 1 during the evacuation travel within a permissible speed range and so as to move the lift cage K1 into the evacuation position determined by the lift control.

In FIG. 3B the weight mass GK1 of the lift cage K1 according to the fourth example of embodiment according to the invention is lighter than the weight mass GGG of the counterweight GG. Correspondingly the upper lift cage K1 is moved into an upper evacuation position.

FIGS. 4A and 4B show a fifth and sixth example of embodiment according to the invention in which the counterweight GG is blocked and the two lift cages K1, K2 remain unblocked. Accordingly, the two lift cages K1, K2 can be moved into an evacuation position. This case occurs, for example, when at the instant of failure of the motors passengers are present in both lift cages K1, K2 or the weight force relationship between the upper and lower lift cages K1, K2 is particularly favourable for movement of the lift cages K1, K2.

After the counterweight GG was blocked by means its blocking unit the holding brakes and/or the regulated cage brakes of the two lift cages K1, K2 are released. During the evacuation travel of the two lift cages K1, K2 the braking moments of the holding brakes counteract the rotational movement of the drive pulleys T1, T2 and/or the braking forces of the regulated cage brakes act oppositely to the movement direction of the lift cages K1, K2, with the object of controlling the travel speeds of the lift cages K1, K2 and moving the lift cages K1, K2 to an evacuation position.

The lift control prioritises a lift cage K1, K2, which is moved first to an evacuation position, on the basis of a criterion K. In FIG. 4A the weight mass GK1 of the upper lift cage K1 is greater than the weight mass GK2 of the lower lift cage K2. An imbalance is thus present between the weight masses GK1, GK2 of the lift cages K1, K2, which is used in order to move one of the lift cages K1 and K2.

In correspondence with a criterion K, which prioritises the evacuation of the heavier lift cage or the lift cage with the greater number of passengers, the upper lift cage K1 is thus moved into a lower evacuation position, whereagainst the lift cage K2 moves upwardly. If one or more passengers is or are also present in the lower lift cage K2, the passenger or passengers is or are evacuated in the next step.

A second case according to FIG. 4A is present when the passengers of the lower lift cage K1 are evacuated with priority. This occurs, for example, when an evacuation position of the lower lift cage K2 is closer than that of the upper lift cage K1. The initiated evacuation method follows the same steps as in the fifth example of embodiment according to FIG. 4A, with the difference that initially the lower lift cage K2 is moved into an upper evacuation position.

FIG. 4B similarly shows an evacuation method in which the counterweight GG is blocked. By contrast to the fifth example of embodiment of FIG. 4A here the weight mass GK2 of the lift cage K2 is greater than the weight mass GK1 of the upper lift cage K1. An imbalance between the weight masses GK2, GK1 of the lift cage K1, K2 is thus equally present, which enables movement of the lift cages K1, K2. In the fifth example of the embodiment, thereagainst, the lift cage K2 moves downwardly and the upper lift cage K1 upwardly. Which of the two lift cages K2, K1 is moved first into an evacuation position is also oriented here to the evacuation priority of the lift cage and/or of the passengers.

In a special case of the evacuation method shown in FIGS. 4A and 4B the occupants of a building can also be evacuated in a case of failure of the motors of the lift cages. For this purpose the counterweight GG is moved to the shaft centre in advance of the actual evacuation method. This similarly takes place with use of the imbalances between the three lift bodies K1, K2, GG. Depending on the respective starting position and weight distribution of the three lift bodies K1, K2, GG the counterweight GG is moved in accordance with one of the functional principles preset in FIGS. 2A to 5B. If, for example, the counterweight GG lies below the shaft centre and if the weight mass GK2 of the lower lift cage K2 is greater than the weight mass GGG of the counterweight, then the upper lift cage K1 is blocked by means of its blocking device and the counterweight GG after release of the holding brake and/or the regulated cage brake of the lower lift cage K2 is moved to the shaft centre. Depending on the respective starting position and weight distribution of the three lift bodies K1, K2, GG, passengers of lift cage K1, K2 must possibly also be moved to an evacuation position, preferably a storey, so as to achieve a weight distribution of the lift bodies K1, K2, GG enabling positioning of the counterweight GG in the shaft centre.

When the counterweight GG has attained a central shaft position, in a first step the counterweight GG is blocked in this position. The holding brakes and/or the regulated brakes of the two lift cages K1, K2 are then released. In the case of presence of an imbalance between the weight mass GK1 of the upper lift cage K1 and the weight mass GK2 of the lower lift cage K2 the two lift cages K1, K2 are operated in a pendulating operation, wherein the upper lift cage K1 is moved between an upper storey and the shaft centre and the lower lift cage is moved between the shaft centre and a lower storey. Passengers present in the upper lift cage K1 are thus moved to the shaft centre. There these passengers transfer from the upper lift cage K1 to the lower lift cage K2 and are ultimately moved to a lower storey from which they can leave the building.

The transfer of the passengers from the upper lift cage K1 to the lower lift cage K2 usually takes place by way of a staircase which connects together two adjacent middle storeys which are one above the other and at which the lift cages K1 and K2 await during the transfer process.

Alternatively, the passengers can without detour transfer by way a staircase directly from the upper lift cage K1 to the lower lift cage K2 if each of the two lift cages K1, K2 has a respective transfer hatch (not shown). The transfer hatch of the upper lift cage K1 is in that case arranged in the lower region of the upper lift cage K1 and the transfer hatch of the lower lift cage K2 is arranged in the upper region of the lower lift cage K2 so that the passengers can transfer in simple manner and without risk from the upper lift cage K1 to the lift cage K2, which waits directly thereunder, via the transfer hatches.

Advantageously, the lift, particularly the lift cages K1, K2, is equipped with information and display means. These information and display means assist the passengers during transfer by means of, for example, audio-visual instructions and thus form a passenger guide. Passengers present in the upper lift cage and moved up to the shaft centre are requested by the information and display means to transfer and are guided by way of further instructions to the lower lift cage K2. During transfer via the staircase the information and display means disposed at the lift cage K1 can be supplemented by whatever means are installed at the building. If, alternatively, transfer is carried out via the transfer hatches, the information and display means instruct the passengers how the transfer hatches of the upper and lower lift cages K1, K2 are to be actuated.

As described in the above evacuation method according to FIGS. 2A to 4B, after failure of the motors the lift cages K1, K2 are moved by means of weight force differences of the unblocked lift cages K1, K2, GG. Since the weight force difference is not always sufficient for movement of the lift cages K1 and K2, the upper lift cage K1, for example, has, as shown in FIG. 5A a lowerable weight M. The weight M is suspended at a winch W by way of a support means S. The winch W is preferably mounted in the lower region of the upper lift cage K1. The weight M can be lowered by the winch W to such an extent until it preferably rests on an upper region of the lower lift cage K2. The lower lift cage K2 is thereby weighed by the weight M, with simultaneous relief of the upper lift cage K1 of the weight M. The weight force difference thus amounts to approximately twice the weight mass of the weight M when the weight M is lowered.

In order to ensure that the weight M over the entire possible evacuation travel rests on the lower lift cage K1, the length of the support means S is preferably to be selected so that the weight M rests on the lower lift cage K1 even with a maximum spacing of the lift cages K1, K2. The support means S thus preferably has a length which corresponds with the distance to the storey, which is furthest away and can be moved to by the lift cages K1, K2, of a lift shaft 11.

In a seventh example of embodiment according to the invention of the evacuation process according to FIG. 5B the counterweight GG is blocked by means of a blocking device in a first step. Then, in a second step the holding brakes and/or the regulated cage brakes of the two lift cages K1, K2 are released. Since an equilibrium prevails between the two lift cages K1, K2, neither of the two lift cages K1, K2 can be moved. Accordingly, in a third step the weight M is lowered by means of the winch W from the upper lift cage K1 onto the lower lift cage K2. Since now the lower lift cage K2 has a weight mass which is higher by 2M than the upper lift cage K2, the lower lift cage K2, for example, is moved downwardly to an evacuation position. The upper lift cage K1 accordingly moves upwardly. The two associated drive pulleys T1, T2 in that case rotate in clockwise sense. The holding brakes exert a torque opposite to the rotational sense and/or the regulated cage brakes exert a braking force opposite to the movement direction of the lift cages K1, K2 so as to control the travel speed of the two lift cages K1, K2 and, for example, to stop the lift cage K2 at an evacuation storey in accordance with a priority criterion.

The weight M is also lowered when a slight weight force difference between the two lift cages K1, K2 is not sufficient to overcome the system friction forces of the lift.

FIGS. 6A, 6B show an eighth example of embodiment according to the invention in which the lower lift cage K2 has, analogously to the lift cage K1 in FIG. 5B, a lowerable weight M. In a first step the counterweight GG is blocked by the blocking device. In a case of presence of an equilibrium between the weight mass GK1 of the upper lift cage K1 and the weight mass GK2 of the lower lift cage K2 the lowerable weight M is lowered by means of the winch W onto the shaft floor SG. Thus, a constrained imbalance between the weight masses GK1, GK2 of the upper and lower lift cages K1, K2 arises. The weight mass GK2 of the lower lift cage K2 is now lighter relative to the weight mass GK1 of the upper lift cage K1 by approximately the weight mass of the weight M resting on the shaft floor. After the holding brake and/or the regulated cage brake of the lift cages K1, K2 are released, the upper lift cage K1 as well as the lower lift cage K2 move downwardly or upwardly in correspondence with the constrained weight force relationship. The associated drive pulleys T1 and T2 both rotate in counterclockwise sense. The holding brakes and/or the regulated cage brakes exert a torque opposite to the rotational sense of the drive pulleys T1, T2 or a braking force opposite to the movement direction of the lift cages K1, K2 so as to control the two lift cages K1, K2 and, for example, to stop the lift cage K1 at a lower evacuation storey in accordance with a priority criterion.

The evacuation method, which is shown in FIGS. 5B and 6B, with the lowerable weight M can be used on any of the examples presented in FIGS. 2A to 4B. If the weight difference between the counterweight GG and an unblocked lift cage K1, K2 is insufficient to move the lift cage K1, K2 to an evacuation storey the lowerable counterweight M of the upper or lower lift cage K1, K2 is lowered onto the lower lift cage K2 or onto the shaft base SG in an additional method step so as to constrain an imbalance between the two unblocked lift bodies GG, K1 or GG, K2. It is also possible to equip each of the two lift cages K1 and K2 with a respective lowerable weight M.

The afore-described basic principles of the evacuation method according to the invention can also be usefully transferred to other operating method such as, for example, assembly processes or maintenance processes in which the energy required for drive of the motors cannot be provided or at least one motor has failed. Thus, in an assembly process lift components can be moved into the shaft with the help of the lift or a service employee can be brought by means of a lift cage into a working position so as to replace a defective motor or repair this on site.

1-12. (canceled)

13. An operating method for an elevator having at least three elevator bodies, which bodies are movable along at least one travel path and are connected together by a support means, wherein first and second ones of the elevator bodies are suspended 1:1 by the support means and a third one of the elevator bodies is suspended 2:1 by the support means, and at least one of the first, second and third elevator bodies can be blocked from movement along the travel path by a controllable blocking device, comprising the steps of:
transporting passengers in the first elevator body;
blocking from movement along the travel path one of the second and third elevator bodies; and
moving the first elevator body to a predetermined position along the travel path when there is an imbalance between a weight of the first elevator body and a weight of an unblocked one of the second and third elevator bodies.

14. The operating method according to claim 13 including transporting passengers in the first and second elevator bodies, blocking from movement along the travel path the third elevator body, and moving one of the first and second elevator bodies when there is an imbalance between weights of the first and second elevator bodies in accordance with a determinable criterion into a predetermined position along the travel path.

15. The operating method according to claim 14 wherein the criterion comprises at least one of a higher number of passengers, presence of a passenger by way of which an identity profile is detected, and a smaller distance from the predetermined position.

16. The operating method according to claim 13 wherein the first elevator body is an upper elevator body having a lowerable weight and said second elevator body is a lower elevator body, and wherein the weight is lowered onto the lower elevator body to produce a weight force difference between the first elevator body and the second elevator body.

17. The operating method according to claim 13 wherein the second elevator body is a lower elevator body having a lowerable weight, and wherein the weight is lowered onto a shaft floor to produce a weight force difference between the first elevator body and the second elevator body.

18. An operating method for an elevator having two elevator cars, each of the cars having a drive with one of a holding brake and a regulated car brake, and a counterweight, comprising the steps of:
blocking a first one of the elevator cars from movement along a travel path;
releasing the holding brake or the regulated car brake of a second one of the elevator cars; and
moving the second elevator car, in response to an imbalance between a weight of the second elevator car and a weight of the counterweight, to an evacuation floor.

19. The operating method according to claim 18 wherein the first elevator car is an upper elevator car having a lowerable weight and the second elevator car is a lower elevator body, and including the steps of:
blocking the upper elevator car;
releasing the holding brake or the regulated car brake of the lower elevator car;
lowering the lowerable weight onto the lower elevator car in response to an equilibrium between a weight mass of the lower elevator car and a weight mass of the counterweight; and
moving the lower elevator car to an evacuation floor by a forced imbalance between the weight mass of the second elevator car and the weight mass of the counterweight.

20. The operating method according to claim 18 wherein the first elevator car is an upper elevator car and the second elevator car is a lower elevator car having a lowerable weight, and including the steps of:
blocking the upper elevator car;
releasing the holding brake or the regulated car brake of the lower elevator car;
lowering the lowerable weight onto a shaft floor in response to an equilibrium between a weight mass of the lower elevator car and a weight mass of the counterweight; and
moving the lower elevator car to an evacuation floor by a forced imbalance between the weight mass of the lower elevator car and the weight mass of the counterweight.

21. The operating method according to claim 18 including the steps of:
blocking the counterweight from movement along the travel path;
releasing the holding brakes or the regulated car brakes of the two elevator cars; and
moving the first elevator car to an evacuation floor in response to an imbalance between a weight mass of the first elevator car and the weight mass of the second elevator car.

22. The operating method according to claim 18 wherein the first elevator car is an upper elevator car having a lowerable weight and the second elevator car is a lower elevator body, and including the steps of:
blocking the counterweight from movement along the travel path;
releasing the holding brakes or the regulated car brakes of the two elevator cars;
lowering the lowerable weight onto the lower elevator car in response to an equilibrium between a weight mass of the upper elevator car and a weight mass of the lower elevator car; and
moving the upper elevator car to an evacuation floor by a forced imbalance between the weight mass of the upper elevator car and the weight mass of the lower elevator car.

23. The operating method according to claim 18 wherein the first elevator car is an upper elevator car and the second elevator car is a lower elevator car having a lowerable weight, and including the steps of:
blocking the counterweight from movement along the travel path;
releasing the holding brakes or the regulated car brakes of the two elevator cars;
lowering the lowerable weight onto a shaft floor in response to an equilibrium between a weight mass of the upper elevator car and a weight mass of the lower elevator car; and
moving the upper elevator car to an evacuation floor by a forced imbalance between the weight mass of the upper elevator car and the weight mass of the lower elevator car.

24. The operating method according to claim 18 including the steps of:
blocking the counterweight at a center of the travel path from movement along the travel path;
releasing the holding brakes or the regulated car brakes of the two elevator cars;
operating the two elevator cars in a pendulating drive mode in response to an imbalance between a weight mass of the first elevator car and the weight mass of the second elevator car, wherein the first elevator car is moved between an upper floor and the travel path center and the second elevator car is moved between the travel path center and a lower floor;
moving passengers present in the first elevator car as far as the travel path center;
transferring the passengers from the first elevator car to the second elevator car; and
moving passengers present in the second elevator car to the lower floor.

25. The operating method according to claim 24 wherein the first elevator car has a transfer hatch in a lower region of the first elevator car and the second elevator car has a transfer hatch in an upper region of the second elevator car, and including the steps of:
moving passengers present in the first elevator car to the travel path center; and
transferring the passengers present in the first elevator car from the first elevator car to the second elevator car through the respective transfer hatches.

26. The operating method according to claim 24 including and information and display means for passenger guidance and further including the steps of:
moving passengers present in the first elevator car to the travel path center; and
providing to the passengers present in the first elevator car on the information and display means, instructions for transfer from the first elevator car to the second elevator car.
